(19) United States
(12) Patent Application Publication
(10) Pub. No.: US 2017/0326517 A1
(43) Pub. Date: Nov. 16, 2017

(54) VALVE ASSEMBLY FOR A DISPENSER DEVICE FOR VOLUMETRIC DISPENSER MACHINE

(71) Applicants: Luca DROCCO, Alba (CN) (IT); Mario DROCCO, Alba (CN) (IT)

(72) Inventors: Luca DROCCO, Alba (CN) (IT); Mario DROCCO, Alba (CN) (IT)

(21) Appl. No.: 15/522,723

(22) PCT Filed: Oct. 27, 2015
(86) PCT No.: PCT/IB2015/058270

§ 371 Date: Apr. 27, 2017

(30) Foreign Application Priority Data
Oct. 28, 2014 (IT) TO2014A000879

(51) Int. Cl. B01F 13/10; B05B 15/02; B05B 1/30; B05B 9/08

(52) U.S. Cl. CPC B01F 13/1058; B05B 15/02; B05B 1/304; B05B 9/0838; B05B 9/0861

(57) ABSTRACT

A dispenser machine includes a dispenser device with a valve assembly. The valve assembly includes at least one distribution duct, at least one distribution nozzle connected to a second end of the distribution duct, at least one first shutter, and at least one valve body, operationally interposed along the distribution duct. The valve assembly includes a closing device for closing the nozzle. The closing device has at least one obstructing element acting upon an aperture of the nozzle for selectively opening or closing the nozzle, and a mechanical connector for connecting the obstructing element to the first shutter, so that switching the shutter will cause the obstructing element to be switched. The shutter is adapted to translate within the valve body between first and second configurations, causing the corresponding obstructing element to switch, respectively, between the closed condition and the open condition.

The present invention relates to a valve assembly for a dispenser device for volumetric dispenser machines.

Said valve assembly comprises a closing device operationally associated with a respective distribution nozzle. Said valve assembly may avoid the need for using a closing cap or “autocap” associated with the distribution head, where a plurality of nozzles are fitted, each one corresponding to a dispenser device.

The present invention also relates to a dispenser device equipped with a valve assembly according to the present invention.

Furthermore, the present invention relates to a dispenser machine equipped with one or more of said dispenser devices, in turn comprising a valve assembly according to the present invention.

The object of the present invention finds particular application in the industrial field of dispenser machines and/or similar machines for customized preparation of fluids, such as coloured paints.

As is known, dispenser machines generally comprise a plurality of dispensing tanks, each one containing a specific dye to be distributed and/or deposited into a can containing a fluid, such as a paint, for giving the latter the desired colour.

Normally a distribution ducts extends from each tank, which ends with a distribution nozzle located at a suitable storage station defined on the machine itself. The storage station is provided with a suitable support platform that defines the supporting plane on which paint cans to be customized are placed. The nozzles of the various dispenser devices normally converge towards said station, thus creating a dispenser head.

Along the distribution duct of each tank, a respective valve assembly and a respective dispenser pump are arranged.

The valve assembly of each distribution duct controls the fluidic connection between the dispenser pump and the tank or the distribution nozzle.

The function of the dispenser pump is to accumulate a predetermined quantity of dye by aspirating it from the respective tank, through the respective distribution duct, when it is in fluidic communication with the latter via the valve assembly, and then to deliver said dye, in a controlled manner, towards the distribution nozzle, when in fluidic communication therewith via the valve assembly.

Although said dispenser machines ensure proper dye distribution, they are normally subject to undesired dye exsiccation along the final tract of the duct, where the distribution nozzles are connected, if the latter are not used often.

More in detail, when the valve assembly of each distribution duct is closed, a significant quantity of dye remains within the respective distribution channel, which is in direct contact with the air. If the respective dispenser pump remains inactive without putting the dye in motion along the respective distribution nozzle, prolonged exposition of the latter to air will inevitably cause it to dry, which may result in severe damage to the individual dispenser device, and hence to the dispenser machine, because it may cause obstruction, whether partial or complete, of the distribution duct and/or nozzle.

In an attempt to overcome this problem, some known solutions provide each distribution duct and nozzle of the dispenser machine with a respective closing device operating at the aperture of the respective distribution nozzle.

Each closing device is adapted to obstruct the aperture of the respective distribution nozzle when the associated valve assembly puts the dispenser pump in fluidic communication with the tank, thereby isolating the distribution nozzle from the pump.

Each distribution nozzle is closed by means of a suitable cap-like element, which is driven by a respective cylindrical actuator, typically a fluid dynamic one.

Although the above-mentioned closing devices can prevent dyes from exsiccating within the distribution nozzles and the distribution duct in case of prolonged inactivity of the latter, the Applicant has found out that they are not exempt from a number of problems and can be improved under several aspects, mostly related to the overall dimensions of the individual actuator device, and hence of the machine as a whole. Moreover, with this solution the machine cannot be equipped with a large number of valve assemblies and distribution nozzles as would be desirable.

The individual dispenser device and the machine as a whole require numerous and assiduous maintenance interventions, resulting in higher costs for manufacturing, marketing and/or using such dispenser machines.

In particular, the Applicant has found that the fluid dynamic actuators of the closing devices are very bulky, so that such dispenser machines tend to have bigger dimensions than dispenser machines lacking such closing devices, since they require suitably shaped distribution ducts.

It should also be taken into account that duplicating, for each distribution nozzle, a closing device provided with a respective fluid dynamic actuator considerably affects the total costs incurred for manufacturing and marketing the dispenser machines, while also requiring a larger number of maintenance interventions, which will inevitably affect the total operating costs of the same.

As aforementioned, a closing device for the entire distribution head, which includes the distribution nozzles, is also known in the art. Such closing device is known in the industry as “autocap”. Such device consists of a closing element or cap adapted to surround and close the dispenser head, for the purpose of preventing the individual nozzles on the head to remain exposed to air after distribution has occurred, an actuator device, and a kinematic mechanism for moving said cap from a disengaged position to an engaged position, in which it is engaged with said head upon activation of the actuator device.

Said autocap is a partial solution to the problem, and is widely used by manufacturers of dispenser machines.

It is the main object of the present invention to propose a valve assembly for a dispenser device for dispenser machines, a dispenser device equipped with the valve assembly, and a dispenser machine equipped with said dispenser device, which can solve the problems observed in the prior art.

It is one object of the present invention to prevent the dye from exsiccating in the distribution nozzles of the individual dispenser devices included in dispenser machines.

It is a further object of the present invention to reduce the overall dimensions of dispenser machines equipped with a closing device for each distribution nozzle.

It is also an object of the present invention to reduce the number of maintenance interventions.

It is yet another object of the present invention to abate the costs incurred for manufacturing, marketing and using the dispenser devices, and hence the volumetric dispenser machines equipped with closing devices for the individual distribution nozzles.

The above-mentioned objects, as well as other objects, are substantially achieved through a valve assembly for a dispenser device for dispenser machines, and through a dispenser device and a dispenser machine equipped with such valve assembly, in accordance with the present invention.

The following description will refer to the annexed drawings, which are supplied merely by way of explanatory and non-limiting example, wherein:

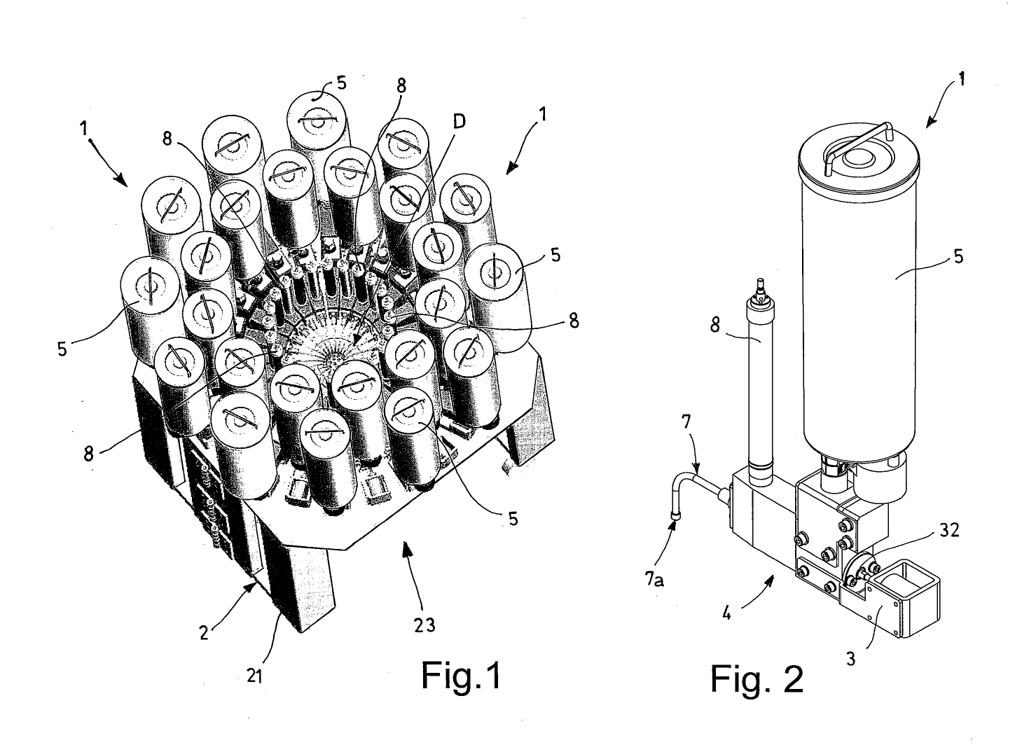

FIG. 1 is a perspective view of a dispenser machine in accordance with the present invention;

FIG. 2 is a perspective view of a dispenser device of the dispenser machine of FIG. 1;

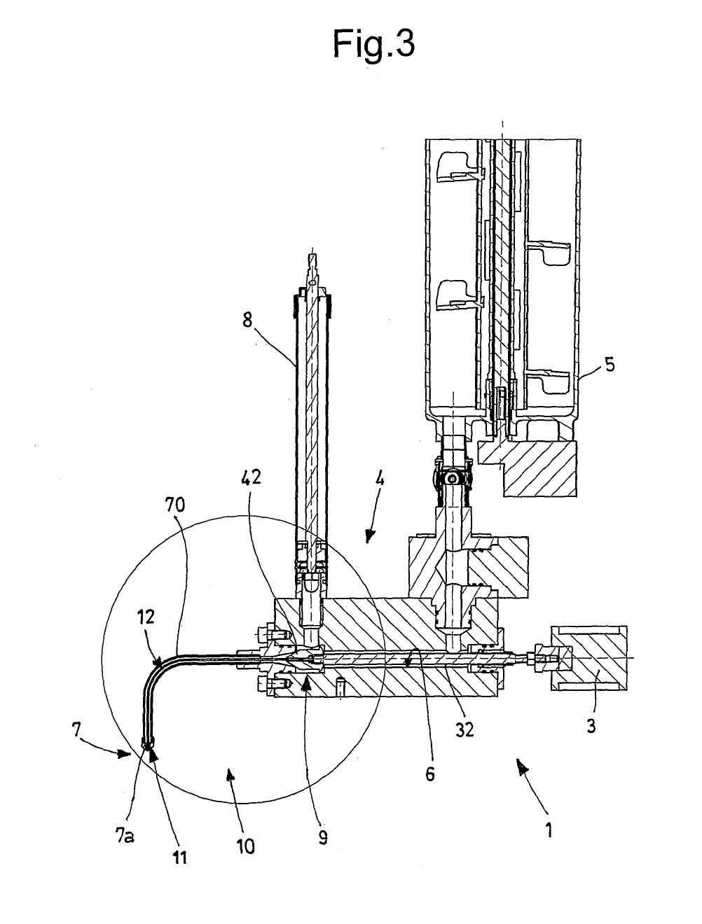

FIG. 3 is a vertical sectional view of the dispenser device of FIG. 2, shown in a significant condition;

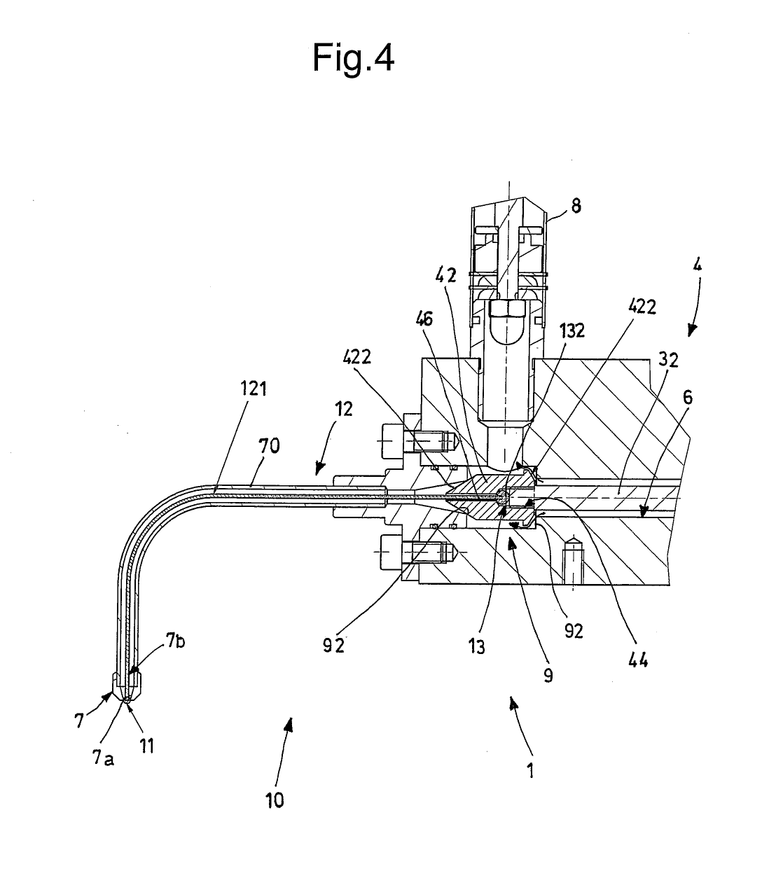

FIG. 4 is an enlargement of a detail of the dispenser device shown in FIG. 3, in particular of a valve assembly;

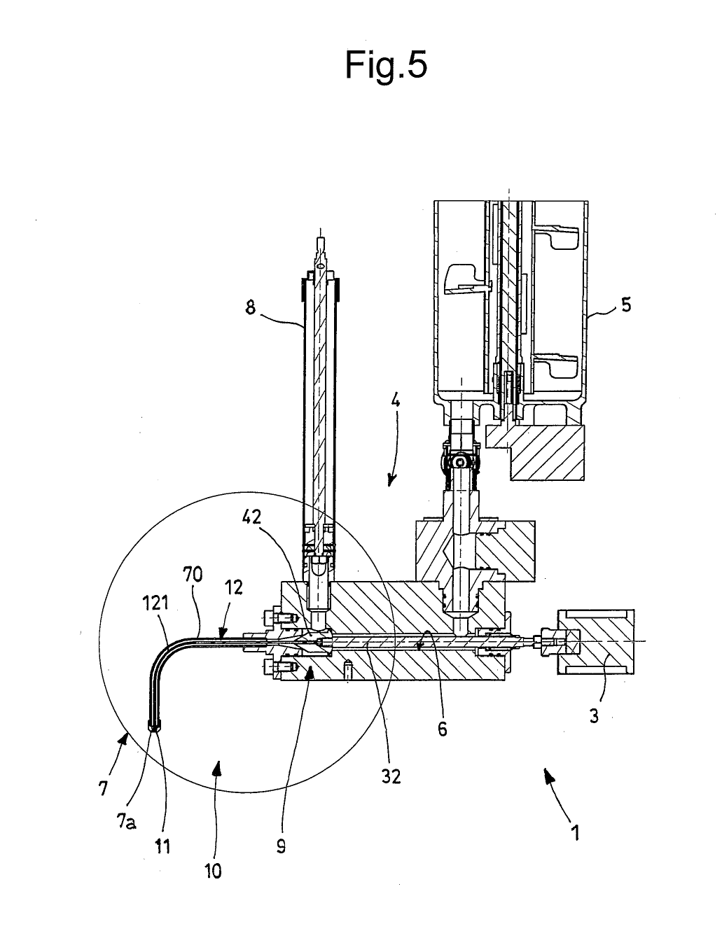

FIG. 5 is a vertical sectional view of the dispenser device of FIGS. 2 and 3, shown in another significant condition;

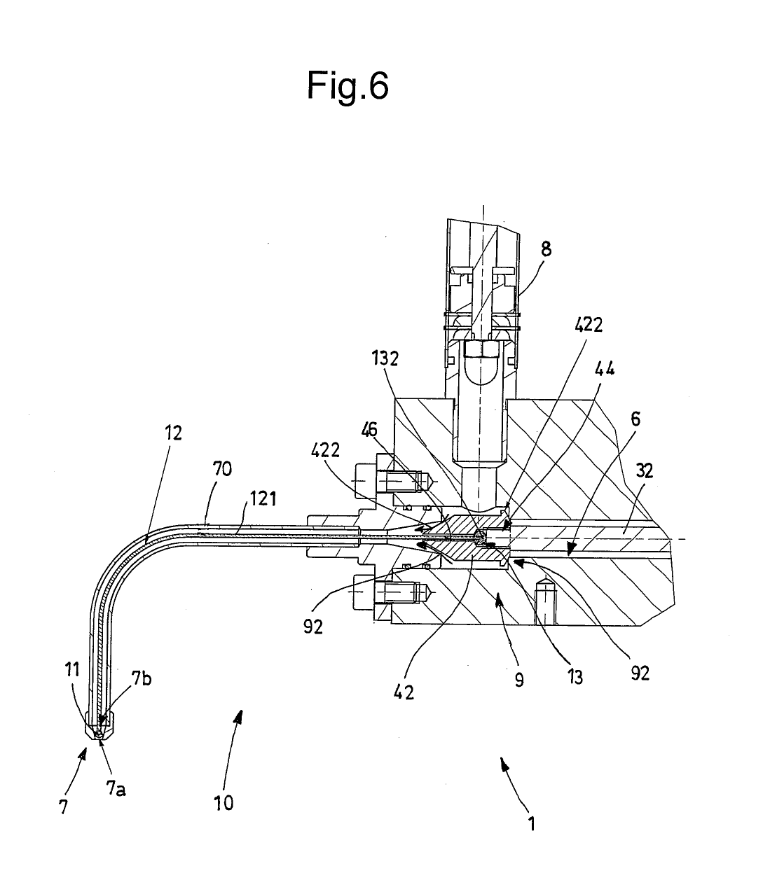

FIG. 6 is an enlargement of a detail of the dispenser device shown in FIG. 5, in particular of the valve assembly;

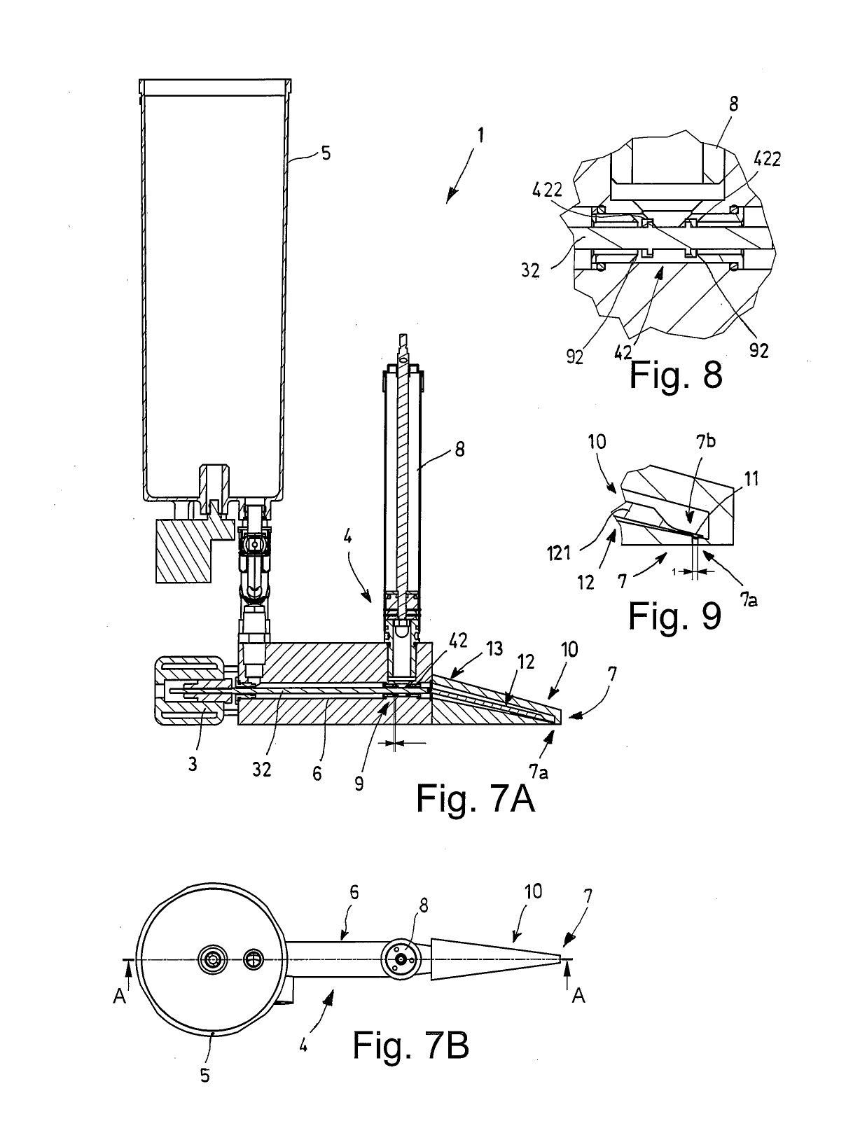

FIG. 7a shows a section A-A of an alternative embodiment of the valve assembly and of the dispenser device;

FIG. 7b is a top view of the valve assembly and of the dispenser device;

FIG. 8 shows a detail of FIG. 7a relating to the valve assembly;

FIG. 9 shows a detail of FIG. 7a relating to the nozzle.

With reference to the annexed drawings, numeral 1 designates as a whole a dispenser device for dispenser machines 2 in accordance with the present invention.

As can be seen in FIG. 1, there is shown a dispenser machine 2 comprising a support structure 21 defining at least one storage station 23 for housing and/or supporting at least one container (not shown) adapted to contain fluids, such as paint, e.g. a can of paint, to be customized, i.e. to be modified as concerns its colour shade.

Still with reference to FIG. 1, dispenser machine 2 comprises at least one dispenser device 1, preferably a plurality of dispenser devices 1, for distributing one or more fluids, such as dyes, preferably simultaneously, into the container, e.g. containing paint to be customized. Dispenser machine 2 is preferably a volumetric one, and comprises a dispenser head or zone “D”, in which dispenser devices 1, in particular a plurality of distribution nozzles 7, converge for dispensing the fluids.

Said dispenser head or zone “D” is located above said dispensing station 23. In said head or zone “D” distribution nozzles 7 converge, which are included in respective dispenser devices 1 grouped together into a bundle. Said distribution nozzles 7 may be comprised in the same head “D” or may only be held in position by the same head “D”. In a further embodiment, distribution nozzles 7 simply converge in a dispensing zone “D” on top of said dispensing station 23.

In an exemplary but non-limiting embodiment, said dispenser device 1 comprises: at least one tank 5 for containing at least one fluid, such as a dye, to be distributed; at least one dispenser pump 8, switchable between an intake condition and a delivery condition. Said pump is preferably a volumetric pump.

Dispenser device 1 comprises a valve assembly 4 according to the present invention. Said valve assembly 4 in turn comprises: at least one distribution duct 6, a first end of which can be connected to a tank 5. The same valve assembly 4 comprises at least one distribution nozzle 7 connected to a second end of said distribution duct 6. Said distribution nozzle 7 has at least one ejection aperture 7a, through which said fluid can exit. Said distribution nozzle 7 is connected to distribution duct 6 either directly or, preferably, via a distribution channel 70.

Said valve assembly 4 comprises at least one valve body 9 operationally interposed along said distribution duct 6 and at least one first shutter 42. In the preferred embodiment, said valve body 9 is formed in said duct 6.

Said valve body 9 comprising a first inlet, facing towards said first end of the duct 6; a first way, to which a dispenser pump 8 can be connected; and a second way, facing towards said second end of the duct 6.

Said at least one first shutter 42 is located in said valve body 9.

Said valve assembly 4, by moving said at least one first shutter 42 within said valve body 9, switches between a first configuration, in which said first way is in fluidic communication with said first inlet and said second way is obstructed; and a second configuration, in which said second way is in fluidic communication with said first way and said first inlet is obstructed.

Valve assembly 4 comprises at least one closing device 10 operationally associated with said distribution nozzle 7, switchable between an open condition, in which said distribution nozzle 7 is in fluidic communication with the outside, and a closed condition, in which said distribution nozzle 7 is isolated from the outside. Said closing device 10 exerts its closing action at the very nozzle 7, thus avoiding any infiltration of air towards distribution duct 6.

Closing device 10 comprises at least one obstructing element 11 operationally arranged at said ejection aperture 7a of said distribution nozzle 7 for selectively opening or closing the latter when closing device 10 is switched. Closing device 10 further comprises at least one connecting element 12 for connecting said obstructing element 11 to said valve assembly 4. The switching of said valve assembly 4 between the first and second configurations causes said closing device 10 to switch, respectively, between the closed condition and the open condition, by moving said at least one obstructing element 11.

In particular, the switching of said first shutter between the first and second configurations will cause said obstructing element 11 to switch, respectively, between the closed condition and the open condition.

As visible in FIGS. 1, 2 and 5, each dispenser device 1 comprises at least one tank 5 for containing at least one fluid, in particular a dye (not shown), to be distributed, for the purpose of making a dispenser machine also capable of simultaneously dispensing more than one fluid.

With reference to FIGS. 1 to 6, each dispenser device 1 comprises at least one dispenser pump 8 operationally arranged along distribution duct 6 at valve assembly 4, connected to said first way of valve body 9. Each dispenser pump 8 can be switched between an intake condition and a delivery condition.

In the embodiment shown in FIGS. 3-6, valve assembly 4 is switchable between a first configuration (FIGS. 3 and 4), in which the respective dispenser pump 8 is in fluidic communication with the respective tank 5 and is not in fluidic communication with the respective distribution nozzle 7, and a second configuration (FIGS. 5 and 6), in which dispenser pump 8 is in fluidic communication with the respective distribution nozzle 7 and is not in fluidic communication with respective tank 5.

Advantageously, each dispenser pump 8 is in the intake condition when the respective valve assembly 4 is in the first configuration (FIGS. 3 and 4), in particular when the first shutter 42 is in the first configuration. In such a configuration, the dye contained in the respective tank 5 flows from the latter towards dispenser pump 8. Pump 8 is in the delivery condition when the respective valve assembly 4 is in the second configuration (FIGS. 5 and 6), in particular when the first shutter 42 is in the second configuration. In such a configuration, the dye taken in is delivered by dispenser pump 8 towards the respective distribution nozzle 7.

Advantageously, each dispenser device 1, and in particular valve assembly 4, is equipped with a closing device 10 operationally associated with the respective distribution nozzle 7.

As aforementioned, closing device 10 is switchable between an open condition (FIGS. 5 and 6), in which the respective distribution nozzle 7 is in fluidic communication with the outside, and a closed condition, in which the respective distribution nozzle 7 is isolated from the outside. In the closed condition, nozzle 7 is sealed, preventing air from entering the same nozzle 7 and flowing towards distribution duct 6.

As visible in FIGS. 3 to 6, closing device 10 of each valve assembly 4 of the respective dispenser device 1 comprises at least one obstructing element 11 operationally arranged at ejection aperture 7a of the corresponding distribution nozzle 7 for selectively opening or closing the latter when closing device 10 is switched between the open condition and the closed condition. Each obstructing element 11 comprises at least one sealing ball. In the preferred embodiment, said obstructing element is preferably a sealing ball operationally arranged at ejection aperture 7a of distribution nozzle 7.

Closing device 10 further comprises connecting elements 12, optionally mechanical ones, for connecting the respective obstructing element 11 to valve assembly 4, in particular to the respective first shutter 42. In this manner, the switching of valve assembly 4 between the first configuration (FIGS. 3 and 4) and the second configuration (FIGS. 5 and 6) causes obstructing element 11 to switch, respectively, between the closed condition, in which it obstructs the respective distribution nozzle 7, in particular ejection aperture 7a, and the open condition, in which it opens the same, in particular ejection aperture 7a.

As visible in FIGS. 3 and 4, connecting means 12 comprise at least one elongated element 121, preferably a cable, more preferably a non-extensible flexible cable. Said elongated element that preferably extends at least inside distribution channel 70 of the respective distribution nozzle 7. On the side opposite to obstructing element 11, elongated element 121 has at least one engagement portion 13 connected to the first shutter 42 of valve assembly 4.

According to the structural configuration of closing device 10 shown in FIGS. 3 to 6, the first shutter 42 is adapted to translate within valve body 9 between the first configuration (FIGS. 3 and 4) and the second configuration (FIGS. 5 and 6), thereby causing the corresponding obstructing element 11 to switch, respectively, between the closed condition and the open condition.

Advantageously, obstructing element 11 of closing device 10 of each valve assembly 4 associated with a dispenser device 1 mainly operates within the respective distribution channel 70 of the respective distribution nozzle 7.

In one possible embodiment, when obstructing element 11 is in the open condition (FIGS. 5 and 6), it is fully located inside the respective distribution nozzle 7; vice versa, when obstructing element 11 is in the closed condition (FIGS. 3 and 4), it is at least partially located inside the respective distribution nozzle 7, protruding at least partially from the respective ejection aperture 7a.

In an alternative embodiment, when obstructing element 11 is in the open condition, it is fully located outside the respective distribution nozzle 7; vice versa, when the obstructing element 11 is in the closed condition, it is at least partially located inside the respective distribution nozzle 7, protruding at least partially from the respective ejection aperture 7a.

For the purpose of retaining the obstructing element 11 in the closed condition, while at the same time providing it with a suitable abutment, ejection aperture 7a of distribution nozzle 7 of each dispenser device 1 has at least one housing 7b, e.g. a restriction (FIGS. 4 and 6), the diameter of which is smaller than the diameter of obstructing element 11. In this case, as visible in FIG. 4, the closed condition of obstructing element 11 is determined by the engagement of the same against housing 7b. Said housing 7b is, for example, a tapered portion.

Still with reference to FIGS. 3 to 6, particularly FIG. 4 and FIG. 6, engagement portion 13 of each elongated element 121 comprises at least one hooking element 132, e.g. a ball. Said hooking element 132 engages into an abutment seat 44 comprised in the first shutter 42.

Advantageously, a passage channel 46 extends from abutment seat 44 through the body of the respective first shutter 42. Said elongated element 121 extends from said engagement portion 13 through said passage channel 46.

Preferably, the diameter of said passage channel 46 is greater than the diameter of obstructing element 11 and smaller than the diameter of hooking element 132 of engagement portion 13 of elongated element 121.

Since elongated element 121 runs through passage channel 46, said elongated element 121 can be pulled through the first shutter 42.

In such a configuration, closing device 10 can be assembled by inserting obstructing element 11 into the passage channel 46 of the first shutter 42 on the side of abutment seat 44. Since obstructing element 11 runs through passage channel 46, elongated element 121 can be pulled through the first shutter 42 until the engagement of hooking element 132, e.g. a ball, of engagement element 13 into abutment seat 44. In this case, hooking element 132 of engagement portion 13 of elongated element 121 will completely obstruct passage channel 46, while elongated element 121 extending therefrom will run through passage channel 46 and the respective distribution channel 70 up to distribution nozzle 7.

In an alternative embodiment, said hooking element 132 is secured to elongated element 121 in a removable manner. During assembly, therefore, elongated element 121 can be threaded into passage channel 46 and, once inserted, said hooking element 132 can be secured to the same elongated element 121. Once hooking element 132 has been secured it is appropriately positioned inside abutment seat 44. In this embodiment, the diameter of passage channel 46 may even be smaller than the diameter of obstructing element 11.

In the embodiment shown in FIGS. 1-6, the first shutter 42 is moved by means of a control actuator 3.

With reference to FIGS. 3 to 6, abutment seat 44 is closed, preferably hermetically, on the side opposite to passage channel 46, by a transmission member 32. Said transmission member 32 extends along the respective distribution duct 6, in a respective control actuator 3.

In the embodiment of FIGS. 2-6, control actuator 3 is of the magnetic induction type.

In an alternative embodiment, instead of being caused by a dedicated control actuator, the movement of said at least one shutter 42 occurs by exploiting the dynamic flows generated by dispenser pump 8 during the respective intake and delivery phases. In this embodiment, the valve assembly comprises two non-return valves, appropriately arranged in such a way as to be activated in opposition for the purpose of obtaining fluid circulation from the tank to the pump and from the pump to the nozzle, as can be easily understood by a man skilled in the art. Closing device 10 is associated with the non-return valve directed towards distribution nozzle 7. In particular, hooking element 132 is secured to the shutter of the non-return valve and, through connecting element 12, the motion is transmitted to the associated obstructing element towards distribution nozzle 7.

Referring back to the embodiment shown in FIGS. 3-6, hooking element 132 of engagement portion 13 at one end of elongated element 121 remains trapped in abutment seat 44 between the body of the first shutter 42 and the transmission member 32.

Still with reference to FIGS. 3 to 6, the first shutter 42 is operationally arranged inside valve body 9. Said valve body, as mentioned above, is interposed along distribution duct 6, and is connected to dispenser pump 8, in particular through said first way.

More in detail, the translation of the first shutter 42 between the first and second operating configurations occurs inside valve body 9.

Advantageously, shutter 42 has closing surfaces 422, preferably inclined relative to the longitudinal development of distribution duct 6, for engaging matching abutments 92 comprised in valve body 9, in order to selectively close the second way to distribution channel 70 directed towards distribution nozzle 7 when shutter 44 is in the first configuration, and the first inlet directed towards tank 5 when shutter 42 is in the second operating configuration.

The operation of valve assembly 4, when associated with a dispenser device 1 as shown in FIGS. 3-6 and described so far mainly in structural terms, is as follows.

When it is necessary to dispense a predetermined quantity of dye through the respective distribution nozzle 7, shutter 42 is switched into the first configuration (FIGS. 3 and 4) in order to close the second way towards the respective distribution channel 70 of distribution nozzle 7, and to put the respective dispenser pump 8 in fluidic communication with the respective distribution duct 6 and tank 5.

The switching of the first shutter 42 into the first configuration causes the respective obstructing element 11 to close the ejection aperture 7a of the respective distribution nozzle 7, which will thus be closed isolating it from the air. The switching of the first shutter 42 occurs through said control actuator 3. In the preferred embodiment, said first shutter 42 is moved by deactivating the magnetic inductor of control actuator 3.

In this situation, dispenser pump 8 is activated in order to take in the dye from respective tank 5 through the respective distribution duct 6. A predetermined quantity of dye will thus flow from the respective tank 5 to the respective chamber of dispenser pump 8.

When a predetermined volume of dye has accumulated in the chamber of dispenser pump 8, the first shutter 42 is switched from the first to the second operating configuration in order to close the first inlet towards distribution duct 6 and tank 5, and to put the respective distribution nozzle 7 in fluidic communication with the respective dispenser pump 8.

The switching of the first actuator 42 from the first to the second operating configuration occurs by activating the magnetic inductor of control actuator 3. The switching of the first shutter 42 causes elongated element 121 to be dragged through the respective distribution channel 70 of distribution nozzle 7, resulting in the obstructing element 11 rising and disengaging from ejection aperture 7a, thus opening it and putting distribution nozzle 7 in fluidic communication with the outside.

In this situation, dispenser pump 8 is switched from the intake condition to the delivery condition, so as to deliver the previously aspirated dye, in a controlled manner, towards distribution nozzle 7, so that it will be delivered into the container, containing, for example, paint to be customized.

When distribution nozzle 7 is inactive, the first shutter 42 and closing device 10 are kept in the first operating configuration in order to obstruct ejection aperture 7a of distribution nozzle 7 and isolate the residual dye in distribution channel 70 from the air, thereby avoiding the undesired phenomenon of dye exsiccation.

FIGS. 7a and 7b illustrate a different embodiment of the present invention. In particular, a dispenser device 1 is shown, wherein said at least one connecting element 12 comprises at least one elongated element 121. On the side opposite do said obstructing element 11, said elongated element 121 has at least one engagement portion 13 connected to said valve assembly 4. In particular, said engagement portion 13 is connected to said first shutter 42, preferably by means of a hinge.

As can be noticed in FIGS. 7a and 9, said obstructing element 11 and said connecting element 12 are integral with each other and slidable relative to said at least one distribution nozzle 7 for the purpose of obstructing/clearing said ejection aperture 7a. In particular, said obstructing element 11 and said connecting element 12 are slidable within said distribution duct 6 (in particular in the part of the distribution duct facing nozzle 7).

Conveniently, said first shutter 42 is associated with a transmission member 32, in particular extending along said distribution duct 6, of the respective control actuator 3.

Engagement portion 13 can be connected to said first shutter 42 or to said transmission member 32 by means of a hinge. As an alternative, this connection can be provided through the use of per se known fastening means, so as to allow the axial motion of the first shutter 42 and the sliding motion of obstructing element 11, in order to allow ejection aperture 7a to be opened/closed.

As can be seen in the detail of FIG. 8, said first shutter 42 and said transmission member 32 are made as one piece. Therefore, engagement portion 13 of connecting element 12 is connected to the assembly made up of said first shutter 42 and said transmission member 32. As an alternative, said first shutter 42 and said transmission member 32 may be connected to each other through per se known fastening means, such as a joint, a fitting, screws or bolts, a threaded union, etc.

Still with reference to the convenient detail shown in FIG. 8, said shutter 42 has closing surfaces 422 for engaging respective matching abutments 92 comprised in said valve body 9 for selectively closing said first inlet and said second way. Conveniently, valve body 9, in particular shutter 42, is provided with gaskets to prevent undesired fluid leakage; for example, soft gaskets may be used, e.g. made of elastomeric synthetic rubber known to those skilled in the art as Viton®, or fluorinated elastomers (FKM or FFKM).

FIG. 9 shows a detail of the part of nozzle 7 in proximity to ejection aperture 7a. Conveniently, obstructing element 11 is made as one piece with connecting element 12. Therefore, obstructing element and connecting element 12 form a rigid assembly. Obstructing element 11 is susceptible of obstructing and clearing ejection aperture 7a as it slides within distribution duct 6.

In particular, thanks to its sliding motion, obstructing element 11 acts upon ejection aperture 7a much like a gate valve.

Optionally, obstructing element 11 may also be coated with a soft sheath/gasket (e.g. made of rubber) to avoid leakage of fluid and entry of air.

With reference to the advantageous variant illustrated above, said obstructing element 11 comprises at least one protuberance for obstructing said ejection aperture 7a. For example, said protuberance may be shaped like a spherical portion or a hemisphere. For example, if ejection aperture 7a has a circular shape, the protuberance shaped like a spherical portion or a hemisphere will contribute to ensuring a better sealing of said ejection aperture 7a, preventing air from entering nozzle 7 and distribution duct 6, thus avoiding the exsiccation of the fluids therein.

Conveniently, therefore, said ejection aperture 7a of said distribution nozzle 7 has at least one housing 7b, the diameter of which is smaller than the diameter of the protuberance of obstructing element 11, so that the closed condition of the latter will be determined by the engagement of said protuberance against said housing 7b.

Of course, also with reference to the variant and details illustrated in FIGS. 7a-9, said shutter 42 is adapted to translate within said valve body 9 between the first and second configurations, causing corresponding obstructing element 11 to switch, respectively, between the closed condition and the open condition.

Conveniently, the stroke of the shutter 42 is comprised between 0.5 and 2 mm, preferably 1 mm.

Optionally, with reference to a dispenser machine including a plurality of dispenser devices 1, said dispenser machine 2 comprises a single control actuator 3, which simultaneously drives all pumps 8 of all valve assemblies 4. When fluid is dispensed by a number of predetermined dispenser devices 1, remaining pumps 8 will push back the fluidic product previously taken in by said pumps 8 directly into the respective containers 5, since the respective first inlets will be open.

The present invention solves the problems observed in the prior art and offers some important advantages.

First of all, the valve assembly ensures optimal sealing of the associated nozzle. For this reason, the various dispenser devices included in dispenser machine 2, each comprising said valve assembly 4, allow optimal sealing of every single distribution nozzle 7 when not in use, thereby preventing exsiccation of the residual dye and avoiding all problems resulting therefrom.

It must also be pointed out that valve assembly 4 comprising closing device 10 thus conceived has minimal dimensions and can be contained within the same dispenser device.

In particular, the overall dimensions of valve assemblies 4, in particular of closing devices 10, applied to dispenser devices 1, is solely determined by the dimensions of the obstructing elements, of the elongated elements, and of the engagement portions of the latter, which are integrated within the dimensions of dispenser device 1 itself.

It should also be taken into account that the smaller dimensions of closing devices 10 make it possible to prearrange a number of dispenser devices at least equal to the number used by traditional dispenser machines not equipped with closing devices for the individual nozzles, which employ a cap for the entire dispenser head, also known as “autocap”.

The structural simplicity of the closing devices also allows a significant reduction of the number of maintenance interventions as well as of the total costs incurred for manufacturing, marketing and using the dispenser machines equipped with closing devices for the individual nozzles comprised in a dispenser head.

The solution according to the present invention avoids the use of systems for closing the entire dispenser head, known in the industry as “autocap”, as described, for example, in patent application US2007012376.

The solution according to the present invention allows the use of traditional distribution channels 70 made, for example, of rubber, resulting in smaller overall dimensions and lower production costs.

Furthermore, the present solution allows the use of nozzles having the same dimensions as those employed in dispenser machines using the dispenser head closing device, thus keeping the size of the dispenser head compact, by way of exemplary but non-limiting example, it allows the creation of a dispenser head equipped with thirty-two nozzles having a diameter not greater than 50 mm.

The dispenser device according to the present invention allows dispensing quantities of less than 0.51 with high dispensing precision.

The present solution also allows using nozzles 7 integrated into the respective distribution channel 70 in which the connecting element is located.

In addition, the present invention allows using dispenser heads having the simple function of grouping into a bundle of nozzles.

The present invention further allows creating a dispensing zone with stand-alone distribution channels, each comprising its own nozzle, without requiring the use of a distribution head.

In an alternative embodiment, it is possible to use distribution channels 70 made of plastic or metallic material, thus making the channel more rigid.

This embodiment allows integrating the distribution nozzle into the distribution channel. This embodiment avoids the use of a distribution head, whether with or without integrated nozzles.

REFERENCE NUMERALS

| | |
|---|---|
| Dispenser device | 1 |
| Dispenser machine | 2 |
| Support structure | 21 |
| Dispensing station | 23 |
| Control actuator | 3 |
| Transmission member | 32 |
| Valve assembly | 4 |
| First shutter | 42 |
| Closing surfaces | 422 |
| Abutment seat | 44 |
| Passage channel | 46 |
| Tank | 5 |
| Distribution duct | 6 |
| Distribution nozzles | 7 |
| Distribution duct | 70 |
| Ejection aperture | 7a |
| Housing | 7b |
| Dispenser pump | 8 |
| Valve body | 9 |
| Abutments | 92 |
| Closing device | 10 |
| Obstructing element | 11 |
| Connecting elements | 12 |
| Elongated element | 121 |
| Engagement portion | 13 |
| Hooking element | 132 |
| Dispenser head or zone | D |

1. A valve assembly for a dispenser device for a dispenser machine, comprising:
at least one distribution duct, a first end of which is connectable to a tank for containing at least one fluid, to be distributed;
at least one distribution nozzle connected to a second end of said distribution duct; said distribution nozzle having at least one ejection aperture, through which said fluid can exit;
at least one first shutter;
at least one valve body operationally interposed along said distribution duct, and comprising:
a first inlet, facing towards said first end of the duct;
a first way, to which a dispenser pump can be connected; and
a second way, facing towards said second end of the duct;
said valve assembly, by moving said at least one first shutter, switches between a first configuration, in which said first way is in fluidic communication with said first inlet and said second way is obstructed; and a second configuration, in which said second way is in fluidic communication with said first way and said first inlet is obstructed;
at least one closing device operationally associated with said distribution nozzle, switchable between an open condition, in which said distribution nozzle is in fluidic communication with the outside, and a closed condition, in which said distribution nozzle is isolated from the outside, the closing device comprising:
at least one obstructing element, operationally arranged at said ejection aperture, for and selectively opening or closing the nozzle upon switching the closing device;
at least one connecting element connecting said obstructing element to said first shutter;
the switching of said valve assembly between the first and second configurations causes said closing device to switch, respectively, between the closed condition and the open condition, by moving said at least one obstructing element;
said shutter is adapted to translate within said valve body between the first and second configurations, causing the corresponding obstructing element to switch, respectively, between the closed condition and the open condition.

2. Valve assembly according to claim 1, wherein:
at least one connecting element comprises at least one elongated element;
on the side opposite to said obstructing element, said elongated element has at least one engagement portion connected to said first shutter.

3. Valve assembly according to claim 2, wherein said engagement portion is connected to said first shutter by a hinge.

4. Valve assembly according to claim 2, wherein said obstructing element comprises at least one protuberance for obstructing said ejection aperture.

5. Valve assembly according to claim 1, wherein said ejection aperture of said distribution nozzle has a housing, a diameter of the housing is smaller than a diameter of the protuberance of the obstructing element, so that the closed condition of the obstructing element is determined by the engagement of said protuberance against said housing.

6. Valve assembly according to claim 1, wherein said obstructing element and said connecting element are integral with each other and slidable relative to said at least one distribution nozzle for obstructing/clearing said ejection aperture.

7. Valve assembly according to claim 6, wherein said obstructing element and said connecting element are slidable within said distribution duct.

8. Valve assembly according to claim 1, wherein said first shutter is moved by a control actuator.

9. Valve assembly according to claim 8, wherein said first shutter is associated with a transmission member, extending along said distribution duct, of the corresponding control actuator;
said engagement portion being connected to said first shutter or to said transmission member by a hinge.

10. Valve assembly according to claim 9, wherein said first shutter 42 and said transmission member ) are made as one piece.

11. Valve assembly according to claim 1, wherein said shutter has closing surfaces for engaging with matching abutments in said valve body for selectively closing said first inlet and said second way.

12. Dispenser device for dispenser machines, comprising:
at least one tank for containing at least one fluid, to be distributed;
at least one dispenser pump switchable between an intake condition and a delivery condition;
a valve assembly operationally connected to said dispenser pump and to said at least one tank, having the features according to claim 1.

13. Dispenser machine comprising:
a support structure;
at least one storage station for storing and supporting at least one container for containing fluids to be customized;
at least one dispenser device for distributing one or more fluids, into said container; wherein at least one of said dispenser devices is a dispenser device according to claim 12.
